(19) United States
(12) Patent Application Publication
(10) Pub. No.: US 2006/0010156 A1
(43) Pub. Date: Jan. 12, 2006

(54) Relational reporting system and methodology

(75) Inventors: Amir Netz, Bellevue, WA (US); Richard R. Tkachuk, Sammamish, WA (US); Cristian Petculescu, Redmond, WA (US); Mosha Pasumansky, Redmond, WA (US); Paul J. Sanders, Seattle, WA (US); Alexander Berger, Sammamish, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/069,314

(22) Filed: Mar. 1, 2005

Related U.S. Application Data
(60) Provisional application No. 60/586,617, filed on Jul. 9, 2004.

(51) Int. Cl. G06F 17/00

(52) U.S. Cl. 707/102

(57) ABSTRACT

A system that facilitates generating a report based upon data within a relational database comprises a mapping component that utilizes mapping functions to associate a multi-dimensional structure with the relational database. A report generator communicates with the multi-dimensional structure to obtain data relating to the relational database and generates a report that includes the obtained data. For example, the mapping component can utilize measure groups to effectuate the association between the multi-dimensional structure and the relational database.

### REFERENCE TO RELATED APPLICATIONS

This application claims the benefit of U.S. Provisional Application Ser. No. 60/586,617 filed on Jul. 9, 2004, and entitled SYSTEMS AND METHODS OF FACILITATING USAGE OF DATABASES. This application is also related to attorney docket number MS309074.02/MSFTP725USA, entitled SYSTEM THAT FACILITATES DATABASE QUERYING, and attorney docket number MS310694.01/MSFTP823US, entitled DATABASE QUERY TOOLS, both filed on Mar. 1, 2005. The entireties of these applications are incorporated herein by reference.

### TECHNICAL FIELD

The subject invention relates generally to database reporting, and more particularly to utilizing multi-dimensional structures in connection with outputting a database-related report.

### BACKGROUND OF THE INVENTION

The evolution of computers with respect to memory storage expansion and processing capabilities has enabled massive amounts of data to be accumulated and analyzed by complex and intelligent algorithms. For instance, given an accumulation of data, algorithms can analyze such data and locate patterns therein. These patterns can then be extrapolated from the data, persisted as content of data mining model(s), and applied within a desired context. With the evolution of computers from simple number-crunching machines to sophisticated devices, services can be provided that range from video/music presentation and customization to data trending and analysis.

Accordingly, tasks that at one time required skilled mathematicians to perform complex operations by hand can now be automated through utilization of computers. In a simplistic example, many individuals, rather than utilizing a skilled accountant to compute their tax liability, quickly enter a series of numbers into a computer application and are provided customized tax forms from such application. Furthermore, in a web-related application, the tax forms can be automatically delivered to a government processing service. Thus, by way of utilizing designed algorithms, data can be manipulated to produce a desired result.

As complexity between relationships in data increases, however, it becomes increasingly difficult to generate an output as desired by a user. In particular, a user may wish to retrieve data in the form of a report, which can include data organized and formatted in a manner that allows a user to easily understand the returned data. For example, the report can be in tabular form with headings, specific fonts, page numbers, and the like. Conventional systems and methodologies for generating these reports, however, are associated with various deficiencies. In particular, anyone attempting to query or write reports against data within conventional databases can utilize a plurality of tools to access such data. For instance, tools exist that allow a user to connect directly to data, which can result in efficient retrieval of such data. Typical users, however, will not be able to utilize such approach, as databases are difficult to comprehend. For example, names utilized for tables and columns therein are often oriented to a particular system and are cryptic. Furthermore, thousands of relationships can exist across a plurality of tables, rendering understanding of such relationships nearly impossible for most users. Additionally, database systems can include vast amounts of data, causing a summarization of such data difficult to obtain without a specialized tool.

Accordingly, to aid users in generating reports from relational databases, intermediary models have been introduced, wherein tables, columns, and relationships are expressed by way of names that are more easily understood by an end user. A user can thus connect to a relational database by way of the intermediary model and generate a report through utilization of such model. Such intermediary models offer improvements over systems that directly connect to a database, as they improve usability (e.g., they are used to more easily enable a user to generate a report). These models, however, do not render generation of a report sufficiently efficient when vast amounts of data are associated with a database. Furthermore, intermediary models are not sufficiently efficient when several data sources are desirably utilized in connection with generating a report.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention relates to various systems and methodologies that enable a customized report to be generated with respect to a relational database. The creation of the report can be enabled by way of mapping a multi-dimensional structure to a relational database, thereby utilizing advantages associated with multi-dimensional structures and overcoming deficiencies of conventional relational reporting systems/methods. This mapping can be effectuated through one or more mapping functions or techniques, wherein such functions enable multi-dimensional structures to be associated with relational databases in a user-friendly manner. Furthermore, the mapping functions/techniques allow for a multi-dimensional structure to be mapped to relational databases that are associated with schemas more complex than star schemas and/or snowflake schemas.

For instance, the multi-dimensional structure can include measure groups that include one or more measures that are measurable by a substantially similar set of dimensions. Furthermore, disparate measure groups can share common dimensions while retaining private dimensions. In another example, measures upon disparate measure groups can be associated with different levels of hierarchies within a multi-dimensional structure. Accordingly, disparate measures can be associated with different relationships in a relational database. In yet another example, dimensions within a multi-dimensional structure that are desirably mapped to a relational database can be related to one another—thereby reducing redundant data within a multi-dimensional structure. Moreover, dimensions can be associated with disparate roles—thus, first data can be output from a dimension when analyzed with respect to a first defined role and second data can be output from the dimension when analyzed with respect to a second defined role. Furthermore, groupings of dimensions can be associated to disparate groupings of dimensions, thereby enabling sharing of attributes between such groupings. These and other mapping functions/techniques can be utilized to sufficiently map multi-dimensional structures to relational databases, and thereby enable reporting upon such relational databases to be achieved more effectively in comparison to conventional reporting systems/methods.

In accordance with one or more aspects of the subject invention, a multi-dimensional structure utilized in connection with generating a report can be an OLAP cube or a portion thereof (such as a dimension, an attribute hierarchy, an attribute, and the like). Furthermore, the relational database can be an OLTP database. A wizard can be employed in connection with building the multi-dimensional structure over the relational database, and a disparate wizard can be employed in connection with producing a report. For instance, a wizard can solicit information relating to data to be included within the report, formatting of the report, and the like. Moreover, a report generated in connection with one or more aspects of the subject invention can be output in a language specified by a user (such functionality can be enabled by way of embedded data within the multi-dimensional structure).

In accordance with another aspect of the subject invention, a multi-dimensional structure can be automatically adapted in response to alterations in data of an associated relational database. For instance, tables and/or data therein can be modified within the relational database, and a multi-dimensional structure associated with such relational database can be automatically updated in accordance with the modification of the relational database. If the multi-dimensional structure cannot be automatically updated, a user can be notified and assisted with manually updating the multi-dimensional structure.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a high-level block diagram of a system that facilitates generating a report associated with a relational database in accordance with an aspect of the subject invention.

FIG. 2 is a block diagram of a system that facilitates generating a mapping between a multi-dimensional structure and a relational database to facilitate reporting with respect to the relational database in accordance with an aspect of the subject invention.

FIG. 3 is a block diagram of a system that facilitates outputting a report with respect to a relational database in a selected language in accordance with an aspect of the subject invention.

FIG. 4 is a block diagram of a system that facilitates generating reports with respect to a plurality of relational databases in accordance with an aspect of the subject invention.

FIG. 5 is a block diagram of a system that facilitates automatically updating a multi-dimensional structure given an alteration in an associated relational database in accordance with an aspect of the subject invention.

FIG. 6 is a block diagram of a system that facilitates determining authorization levels of a user with respect to a multi-dimensional structure in accordance with an aspect of the subject invention.

FIG. 7 is a flow diagram illustrating a methodology for generating a report with respect to a relational database by utilizing a multi-dimensional structure in accordance with an aspect of the subject invention.

FIG. 8 is a flow diagram illustrating a methodology for employing a wizard to create a report with respect to a relational database in accordance with an aspect of the subject invention.

FIG. 9 is a flow diagram illustrating a methodology for updating a multi-dimensional structure given a modification in an associated relational database in accordance with an aspect of the subject invention.

FIG. 10 is a flow diagram illustrating a methodology for generating a report with respect to a relational database in accordance with an aspect of the subject invention.

FIG. 11 is an exemplary report that can be output to a user in accordance with an aspect of the subject invention.

FIG. 12 is an exemplary computing environment that can be utilized in connection with the subject invention.

FIG. 13 is an exemplary operating environment that can be employed in connection with the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

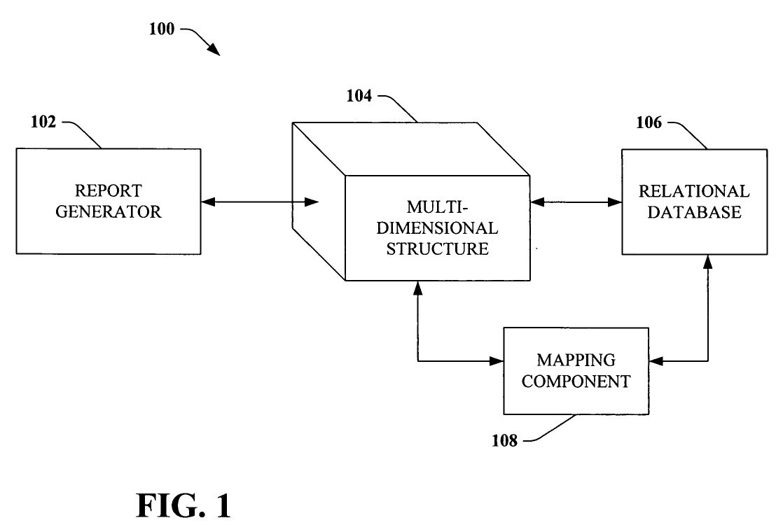

Referring now to the drawings, FIG. 1 illustrates a high-level system overview in connection with one or more aspects of the subject invention. The subject invention relates to a system 100 that facilitates generating a relational report through utilization of one or more multi-dimensional structures, such as data cubes, dimensions therein, and the like. The system 100 includes a report generator 102 that can be utilized to create a report in a manner desired by a user. For instance, the report can be a summary of particular types of data that have been accumulated over time, a summary of related data, and/or a summary of any data desirably reviewed by a user. Furthermore, a report output by the report generator 102 can present data in a customized format. For example, a report that includes a table with a specified number of columns and rows can be output by the report generator 102, as well as a report including specified headings, fonts, colors, and the like. Thus, the report generator 102 can output a customized summary of specified data.

To generate the report, queries can be issued to a multi-dimensional structure 104 that is mapped to a relational database 106. In accordance with one aspect of the subject invention, the multi-dimensional structure 104 can be one or more Online Analytical Processing (OLAP) cubes. OLAP has conventionally been utilized to query for data, and is more expedient in comparison to other querying systems/methodologies. The relational database 106 can be an Online Transaction Processing (OLTP) database, which relates to a form of transaction processing conducted by way of a computer network. OLTP databases are often utilized in calculation intensive applications, such as banking, order processing, e-commerce, and the like. It is understood, however, that any suitable multi-dimensional structure as well as any suitable relational database structure is contemplated by the inventors of the subject invention and intended to fall under the scope of the hereto-appended claims.

OLAP structures and other multi-dimensional structures, however, have not been utilized in connection with reporting services, as relational schemas often utilized in connection with generating reports are significantly more complex than star schemas—accordingly, multi-dimensional structures have not been readily associable with complex relational schemas. The system 100 overcomes such deficiencies by way of providing a mapping component 108 that utilizes various functionalities (hereinafter referred to as “mapping functionality”) to map the multi-dimensional structure 104 to the relational database 106 at build-time of the multi-dimensional structure 104, regardless of complexity of a schema associated with such relational database 106. For instance, the mapping component 108 can produce various measure groups within the multi-dimensional structure, where each measure group can include one or more measures that are measurable by a substantially similar set of dimensions. Furthermore, disparate measure groups can share common dimensions while retaining dimensions solely relating to each measure group. For example, if the multi-dimensional structure 104 relates to sales, then such structure 104 can include a measure group entitled “Sales Detail” with a measure “Sale Quantity”, which can be measured against dimensions relating to products, customers, and time. The multi-dimensional structure 104 can further include a measure group “Order” with a measure “Freight Charge” that can be measured against the dimensions relating to customers and time (but not products). The two disparate measure groups can correspond to two different tables in the relational database 106, wherein both tables can include information relating to sales.

In another example, the mapping component 108 can relate measures within a measure group of the multi-dimensional structure 104 to a substantially similar level of granularity with respect to a hierarchy within a dimension of such structure 104. More particularly, each measure on a measure group can be measurable by a substantially similar set of dimensions, and can also be measurable at a substantially similar level of granularity of an attribute hierarchy (although measures on disparate measure groups can be known at different granularities). Accordingly, measure groups can state granularity associated therewith, allowing specification of disparate relationships to the relational database 106. For instance, “Sales Detail” measures and “Forecast” measures may be known by a time dimension, but may be known at disparate levels of granularity (e.g., “Sales Detail” measures may be known to a day level while “Forecast” measures can be known to a month level). These disparate associations with respect to granularity correspond to different relationships in the relational database 106.

Dimensions within the multi-dimensional structure 104 can be related to one another by way of the mapping component 108 to facilitate mapping the multi-dimensional structure 104 to the relational database 106. In particular, the relational database 106 can include various tables that can be associated with a single dimension, and such tables can be shared across several different dimensions. For example, information relating to a customer may be defined in a table assigned to the customer and a related table defining a geographic region in which a customer resides. Similarly, information relating to a salesman can exist in a table for such salesmen as well as the aforementioned table defining the geographic region (for which the salesman is responsible). Rather than requiring details of the geographic region to be separately included in disparate dimensions (with significant repetition of data and reduced performance), the mapping component 108 can specify different dimensions as being related. For instance, dimensions relating to the customer, the salesman, and the geographic region can be defined as related, where both the dimension relating to the customer and the dimension relating to the salesman can reference the dimension relating to the geographic region. Thus, the dimensions relating to the customer and the salesman can both include attributes from the dimension relating to the geographic region in their respective hierarchies. As can be readily determined by this example, numerous relations can be defined amongst dimensions, thereby significantly decreasing redundancies in detail and enabling mapping between the multi-dimensional structures 104 and the relational database 106 to be accomplished in a more efficient manner.

The mapping component 108 can further map the multi-dimensional structure 104 to the relational database 106 by way of enabling dimensions within the multi-dimensional structure 104 to be associated with particular roles. For instance, the relational database 106 can include multiple relationships between a table containing measures and any suitable dimension table. In a specific example, an order can be billed to one customer and thereafter delivered to a disparate customer. Accordingly, a customer can be associated with disparate roles—a “bill to” customer and a “ship to” customer, and it may be desirable to analyze sales by the disparate roles of a customer at different times. Rather than utilizing two separate dimensions, wherein such dimensions are defined for the two roles of a customer, the mapping component 108 can cause a single dimension two be employed twice within the multi-dimensional structure 104.

To further facilitate generating a report by way of the multi-dimensional structure 104, the mapping component 108 can associated a group of dimensions with a disparate group of dimensions within the multi-dimensional structure 104. The multi-dimensional structure 104 can then handle double counting of particular data, thereby enabling generation of a report to be completed efficiently. For instance, the relational database 106 can include a set of tables that contain details for a single dimension, wherein such set of tables does not conform to a simple schema that is easily mapped to the multi-dimensional structure 104. For example, a product can be stored in disparate aisles within a retail establishment, and an aisle therein can include several products. Rather than simply analyzing a sale against a product, it may be desirable to analyze sales by aisles, which can present various difficulties. In particular, if a sale of a product that exists in two aisles is counted as contributing to both aisles, it is necessary to avoid counting the sale twice when totaling sales across aisles. Further, an allocation of sales across aisles may be desirable. For instance, sales can be allocated equally across all aisles that include the product, can be allocated by disparate percentages for different aisles, and the like. Rather than significantly transforming data within the relational database 106 prior to building the multi-dimensional structure 104, double counting can be handled directly within the multi-dimensional structure 104 (and eliminated with respect to the relational database 106) by enabling groups of dimensions to be associated with disparate groups of dimensions within the multi-dimensional structure 104.

The mapping component 108 can also define multiple hierarchies within a dimension of the multi-dimensional structure 104, wherein data can be analyzed by way of such hierarchies. For instance, sales to a customer can be analyzed according to a location (e.g., city, state, country) in which the customer resides, a sales region (e.g., sub-region, region) to which the customer is allocated, and a size of the customer. Rather than defining separate dimensions for each hierarchy (with significant repetition of detail therebetween), the mapping component 108 can create a single dimension that includes a full set of attributes making up such dimension (e.g., city, state, country, sub-region, region, size, customer name, . . . ). The dimension created by the mapping component 108 can include a plurality of hierarchies, each hierarchy defining a hierarchy of attributes by which data can be analyzed. Accordingly, as attribute definitions can be shared across multiple hierarchies within a single dimension, improved scalability and performance can be achieved. Furthermore, a set of hierarchies can cover every attribute on a dimension, thereby enabling any suitable set of attributes to be included in a query (which can provide flexibility commonly needed for relational database reporting).

Once the multi-dimensional structure 104 is appropriately mapped to the relational database 106 by way of the mapping component 108, the report generator 102 can receive input from a user relating to a report desirably created that includes data within the relational database 106. The report generator 102 can format the input in a manner appropriate for querying the multi-dimensional structure 104, which can then be utilized to retrieve data from the relational database 106. The appropriate data can thereafter be returned to the report generator 102, which can in turn provides a customized report to the user.

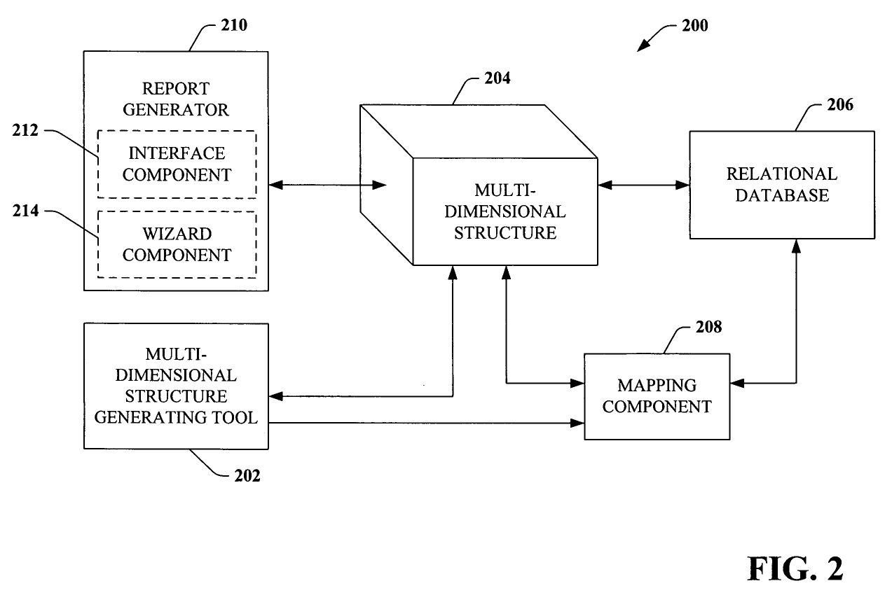

Turning now to FIG. 2, a system 200 that facilitates creating a report in accordance with data existent within a relational database is illustrated. The system 200 includes a multi-dimensional structure generating tool 202 that is utilized to create a multi-dimensional structure 204 that is to be mapped to a relational database 206. A mapping component 208 can be utilized to map the multi-dimensional structure 204 to the relational database 206 during creation of such structure 204, and can employ at least one of the functionalities described above (FIG. 1) to map the multi-dimensional structure 204 to a relational database 206. The mapping component 208 and/or the multi-dimensional structure generating tool 202 can further employ various other techniques associated with multi-dimensional environments and/or intermediary models utilized to obtain data from relational databases. For instance, the mapping component 208 and/or the multi-dimensional structure generating tool 202 can utilize naming conventions to name dimensions, attribute hierarchies, attributes, and the like in a manner that is readily understandable by users. Other known conventional advantages/implementations of the multi-dimensional structure 204 are contemplated by the inventors of the subject invention and are intended to fall under the scope of the hereto-appended claims.

Once the multi-dimensional structure 204 has been created and appropriately mapped to the relational database 206, a report generator 210 can be provided to facilitate generation of a report that is customized according to user preferences. The report generator 210 can be associated with an interface component 212 that is utilized to receive and/or solicit information from a user. For instance, the user interface component 212 can be a keyboard, a graphical user interface (GUI), a microphone and associated voice recognition hardware/software, a pressure-sensitive screen, a pointing and clicking mechanism, speakers, and the like. The interface component 212 can act in conjunction with a wizard component 214 to assist a user in generating a report that is based upon data within the relational database. For instance, the wizard component 214 and the interface component 212 can act together to provide the user with a series of selectable actions and/or questions to facilitate generation of a report. Radio buttons, editable forms, and the like can be utilized to receive information from the user. Thus, the user can provide the report generator 210 with information relating source of data, name of a server, associating a report with a project, whether the report is associated with a shared data source or a new data source, assistance with respect to a query string, a report format, a specific design of the report, fonts, headers, style of a table, language in which to present data, report name, deployment of the report, file format in which to save the report, and any other suitable information that can be utilized in connection with generating the report. Upon obtaining sufficient information, the report generator 210 can retrieve data from the relational database 206 by way of the multi-dimensional structure 204 (or retrieve data from the multi-dimensional structure 204 directly) to enable generation of the customized report. Such report can then be presented to the user by way of the interface component 212.

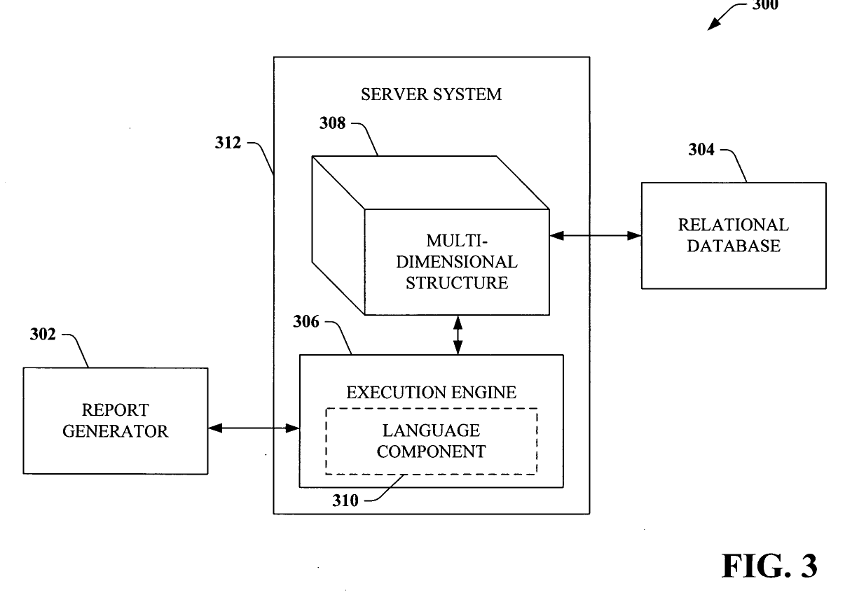

Now turning to FIG. 3, a system 300 that facilitates generation of a relational report by way of a multi-dimensional structure is illustrated. The system 300 includes a report generator 302 that is utilized to provide to a user a customized report relating to data within a relational database 304. For instance, the report generator 302 can be utilized to solicit information from a user, retrieve data relating to the relational database 304, and then create a report in accordance with the solicited information and the retrieved data. In a particular example, the report generator 302 can provide one or more queries to an execution engine 306, which then executes such queries against a multi-dimensional structure 308. For instance, the multi-dimensional structure 308 can be a data cube, a dimension associated with a data cube, an attribute hierarchy associated with a dimension, an attribute, and/or a member of a dimension. The multi-dimensional structure 308 can be mapped to the relational database 304 to enable efficient retrieval of data from such relational database 304. Similarly, if the multi-dimensional structure 308 includes aggregated data, data can be extracted directly therefrom. The multi-dimensional structure 308 can be mapped to the relational database by a mapping component (FIGS. 1 and 2) that utilizes aforementioned mapping functionality to effectuate the mapping. This enables multi-dimensional structures to be mapped to relational databases that are associated with complex schema.

The execution engine 306 can be associated with a language component 310 that enables a report to be provided to a user in a desired language. For instance, a user in the United States of America will typically wish to have a report generated in English, while a user in Germany will typically wish to have a report generated in German. The multi-dimensional structure 308 and the execution engine 306 can be associated with support for a plurality of languages, and data can be provided to the report generator 302 in a language specified by a user and/or automatically selected as a function of user history and/or context. The multi-dimensional structure 308, the execution engine 306, and the language component 310 can be housed within a server system 312, such as an OLAP server system. While shown as being outside the server system 312, it is understood that the report generator 302 and the relational database 304 can also be housed within the server system 312. Upon receiving adequate information from the multi-dimensional structure 308, the report generator 302 can create a customized report and provide such report to a user.

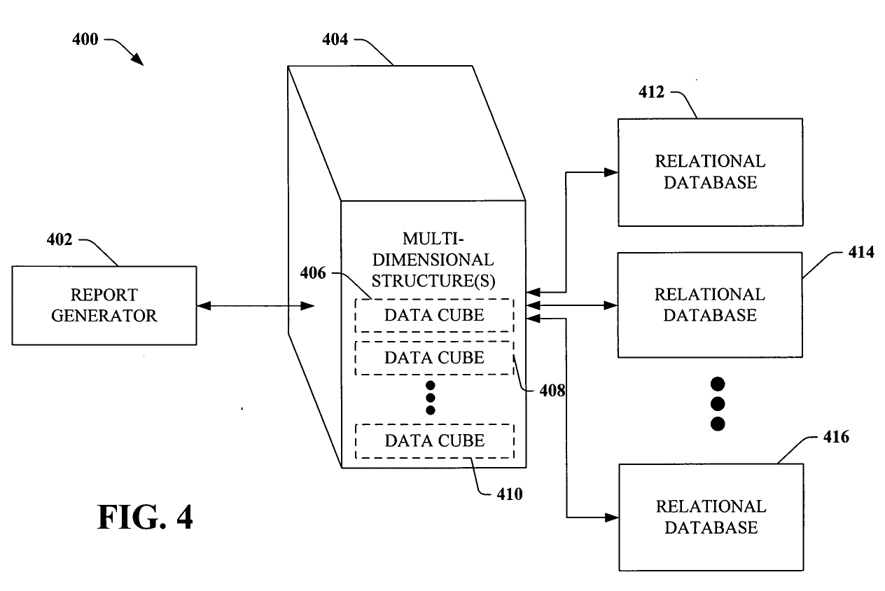

Now turning to FIG. 4, a system 400 that facilitates generating a customized report with respect to data within a plurality of relational databases is illustrated. The system 400 includes a report generator 402 that receives/solicits information from a user relating to creation of a relational report. For instance, the information can relate to data desirably retrieved, format of a report, and the like. The report generator 402 can relay query statements to multi-dimensional structures 404, which can include a plurality of data cubes 406-410. In accordance with one aspect of the subject invention, the query statements can be delivered in a declarative language, such as Multidimensional Expressions (MDX). One or more of the data cubes 406-410 can be mapped to relational databases 412-416 at least partially by way of a mapping component and mapping functions described with respect to FIG. 1. This mapping enables data from a plurality of disparate sources (e.g., the relational databases 412-416) to be more easily mapped to one or more multi-dimensional structure (e.g., the relational databases 412-416). Accordingly, data requested by the report generator 402 can be quickly retrieved from an appropriate relational database if such data is not already existent within one of the data cubes 406-410. The retrieved data can then be utilized in connection with generating a report that is created in accordance with user preferences.

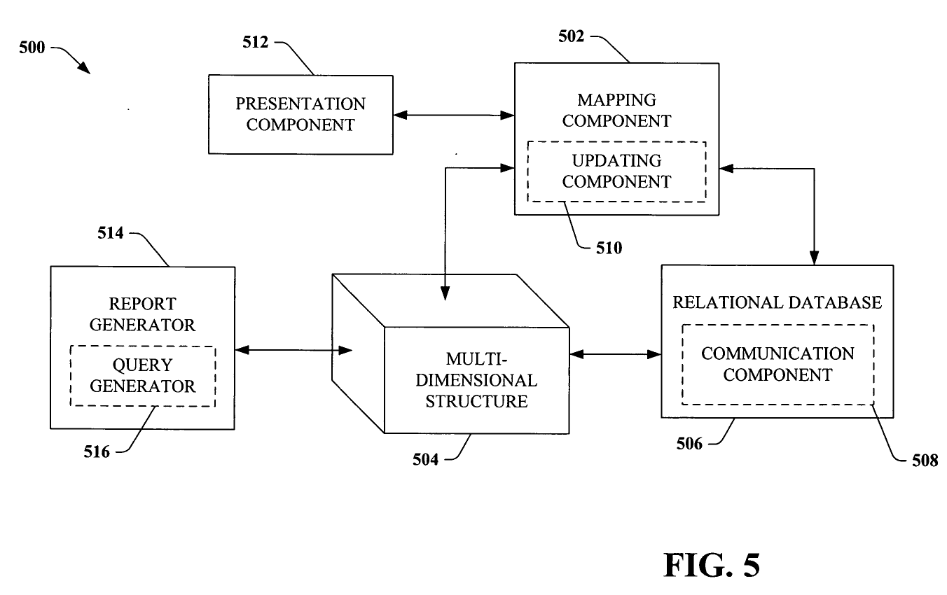

Referring now to FIG. 5, a system 500 that facilitates creating a report that is based at least in part upon data within a relational database is illustrated. The system 500 includes a mapping component 502 that utilizes one or more mapping functions/mechanisms to associate a multi-dimensional structure 504 with a relational database 506. For instance, dimensions of the multi-dimensional structure 504 can include role-based attributes, thereby reducing redundancy within dimensions. Other suitable mapping functions that can be utilized in connection with associating the multi-dimensional structure 504 with the relational database 506 are described infra. The relational database 506 is associated with a communication component 508 that notices when data within the relational database 506 has been subject to alteration. For instance, if a table is added to the relational database 506, the communication component 508 can recognize such addition and inform the mapping component 502 of the addition of such table. The mapping component 502 can include an updating component 510 that automatically updates the multi-dimensional structure 504 in accordance with added, deleted, and/or altered data. Such automatic updating ensures that the multi-dimensional structure 504 continues to map properly to the relational database 506.

If the updating component 510 cannot automatically update the multi-dimensional structure 504 given a data addition, deletion, and/or alteration, the mapping component 502 can inform a user of the added data by way of a presentation component 512 (such as a GUI). For instance, if a table is added and the updating component 510 cannot determine a structure (e.g., a dimension, attribute hierarchy, or the like) that relates to the added table, then the user can be alerted to the addition of such table by way of the presentation component 512. The user then can then manually update the multi-dimensional structure 504 to map to the relational database 506 as desired (and with aid of a cube update tool).

The system 500 further includes a report generator 514 that is utilized to receive information from a user and generate a report according to such information. As described previously, a report is a summary of particular data associated with the relational database 506, wherein such report is formatted in a manner desired by the user. The report generator includes a query generator 516 that can be utilized to deliver queries to the multi-dimensional structure 504, wherein such queries enable the report generator 514 to obtain sufficient information from the multi-dimensional structure 504 and/or the relational database 506 to generate a customized report. For instance, the query generator 516 can receive information relating to type or content of data desirably included within the report, and thereafter translate such information into a query that is understood by the multi-dimensional structure 504 and/or an execution engine (not shown) associated therewith. Thus, the query generator 516 can assist a user in creating complex queries when such user is not an expert in database query language.

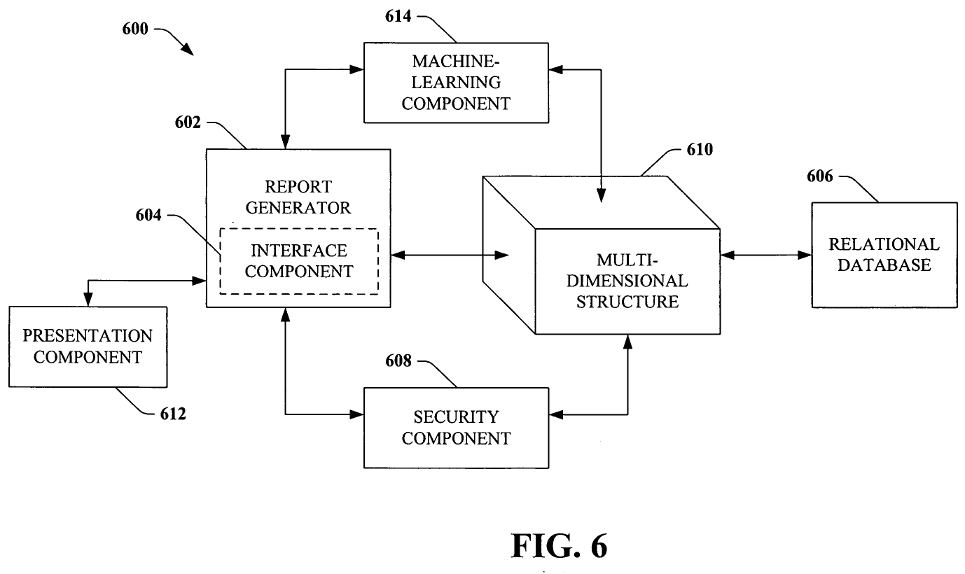

Turning now to FIG. 6, a system 600 that facilitates securing a multi-dimensional structure and/or a report generator from utilization by unauthorized individuals/entities is illustrated. The system 600 includes a report generator 602 that is associated with an interface component 604, wherein the interface component 604 receives/solicits information relating to generating a report that includes data associated with a relational database 606. The report generator 602 is associated with a security component 608 that ensures that a user is authorized to create a report by way of a multi-dimensional structure 610 that is at least partially mapped to the relational database 606. For instance, the security component 608 can employ conventional techniques, such as username, password, and/or personal identification number (PIN) analysis to determine whether a user is authorized to generate a report, access the multi-dimensional structure 610 and/or modify the multi-dimensional structure 610. In another example, the security component 608 can analyze biometric indicia associated with a user to determine whether the user is authorized to access particular data, generate a report, utilize the multi-dimensional structure 610, and the like. Specifically, the security component 608 can be employed to undertake one or more of a fingerprint analysis, voice analysis, retina scan, or any other suitable technique for determining identification of a user through biometric indicia.

The security component 608 can determine and enforce user-access with respect to disparate portions of the multi-dimensional structure 604 (and thus disparate portions of the relational database 606), as well as enforce disparate security levels with respect to a user and at least a portion of the multi-dimensional structure 610. For instance, for one portion of the multi-dimensional structure 610 or certain sets of data within the relational database 606 a user may not have appropriate access rights to generate a report based upon such portion or sets, and for yet a disparate portion of the multi-dimensional structure 610 or certain sets of data within the relational database 606 the user may be uninhibited from accessing and utilizing such data within a report. Thus, the security component 608 can implement multiple levels of security with respect to disparate users and different portions of the multi-dimensional structure 610 and/or the relational database 606.

Upon the security component 608 determining that the user is authorized to access and utilize requested data associated with the multi-dimensional structure 610 and/or the relational database 606, the report generator 602 can issue a query to the multi-dimensional structure 610 to generate a report. Data can be returned to the report generator 602 by way of the multi-dimensional structure 610, and a report customized to user specifications can be created. The system 600 further includes a presentation component 612 that provides a report created by the report generator 604 to a user. For instance, the presentation component 612 can be a LCD display, a CRT display, a plasma display, or any other suitable display device. Similarly, the presentation component 612 can utilize speakers or other audio generating device to present desired output to the user. Thus, the presentation component 612 can output calculations in any suitable manner that enables such user to quickly comprehend the returned data.

The system 600 can also utilize a machine-learning component 614 in connection with updating mapping between the multi-dimensional structure 610 and the relational database 606. Furthermore, the machine-learning component 614 can be employed to assist the report generator 602 in connection with creating an optimal report to present to a user. In particular, the machine-learning component 614 can watch operation of the system 600 over time and make inferences to improve operation of such system 600. As used herein, the terms to “infer” or “inference” refer generally to the process of reasoning about or inferring states of a system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

For example, data within the relational database 606 can be altered, rendering a current mapping between the multi-dimensional structure 610 and the relational database 606 obsolete. The machine-learning component 614 can analyze previous as well as existing mappings and relationship and compute a probability associated with effectuating a proposed mapping. For instance, the machine-learning component 614 can calculate a probability associated with updating a dimension within the multi-dimensional structure 610 to map to an altered table or tables within the relational database 606. If the computed probability is above a pre-defined threshold, then the machine-learning component 614 can effectuate the alteration in mapping. In accordance with another aspect of the subject invention, the machine-learning component 614 can undertake a cost-benefit analysis prior to altering the multi-dimensional structure 610 to map to the relational database 606. For example, the machine-learning component 614 can weigh costs of causing an incorrect alteration to the multi-dimensional structure 610 with benefits of correctly modifying the multi-dimensional structure 610 in view of computed probabilities associated with the proposed alteration. Moreover, the machine-learning component 614 can operate in conjunction with the report generator 602 to facilitate creating a report that is desirably formatted. For instance, the machine-learning component 614 can analyze data requested and infer an optimal format to display such data.

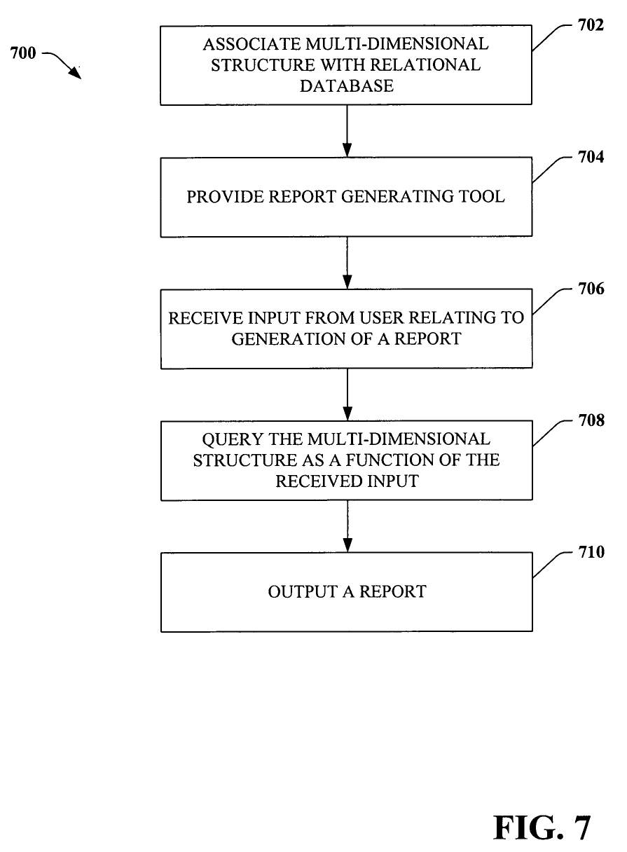

Now referring to FIGS. 7-10, methodologies in accordance with various aspects of the subject invention are illustrated. While, for purposes of simplicity of explanation, the methodologies are shown and described as a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Now turning solely to FIG. 7, a methodology 700 that facilitates generation of a report that utilizes relational data is illustrated. At 702, a multi-dimensional structure is associated with a relational database. In particular, the multi-dimensional structure can be associated with metadata that enables portions within the multi-dimensional structure to be mapped to data within the relational database. For example, a dimension within the multi-dimensional structure can be mapped to a table within a relational database, a column within a relational database, a row within a relational database, or the like. Various mapping techniques are contemplated by the inventors of the subject invention, and such techniques are intended to fall under the scope of the hereto-appended claims. In particular, the mapping functions described with respect to the mapping component of FIG. 1 can be utilized to associate the multi-dimensional structure with the relational database.

At 704, a report generating tool is provided, wherein such tool can access data within the multi-dimensional structure and/or data within the relational database by way of the multi-dimensional structure. The report generating tool can be employed to create a report that includes data associated with the relational database, and such report can be formatted as desired by the user. At 706, input is received from a user relating to generation of a report. For instance, the input can relate to data desirably included within the report, location of the data, format of the report, name of the report, and the like. At 708, the multi-dimensional structure is queried as a function of the received input. For instance, a SQL-based declarative language, such as MDX, can be utilized to query the multi-dimensional structure. The query enables an execution engine to return desired data to the report generator. At 710, a report is output to a user, wherein such report accords to the previously received user input. Conventionally, a relational intermediary model is used to generate reports—however, these are complex and do not function efficiently given a significant amount of data. By utilizing a multi-dimensional structure, reports can be generated without significant regard to size of a relational database.

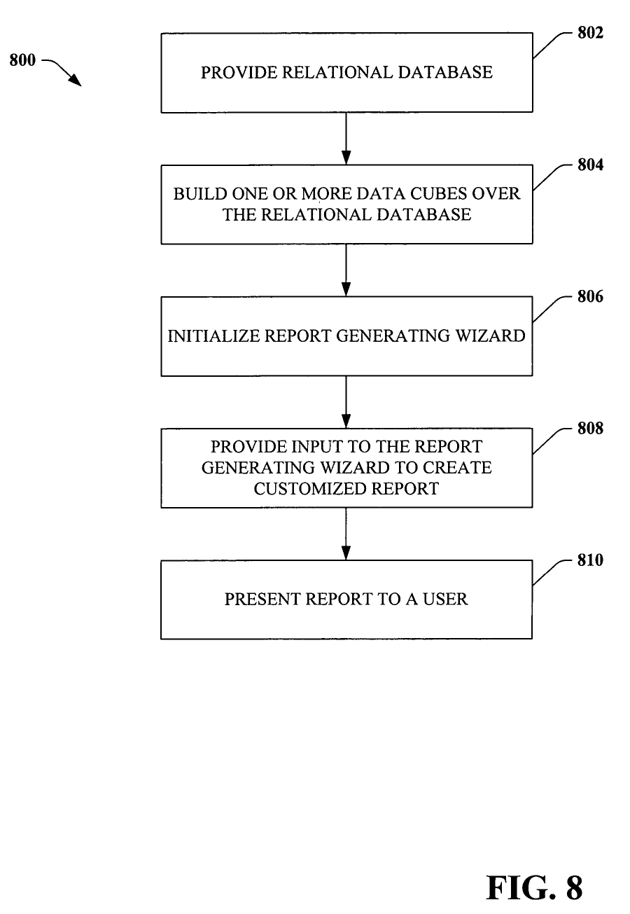

Referring now to FIG. 8, a methodology 800 that facilitates generating a relational report is illustrated. At 802, a relational database is provided. In accordance with one aspect of the subject invention, the relational database can be an OLTP database; however, any suitable relational database can be utilized in connection with the methodology 800. At 804, one or more data cubes are built over the relational database, thereby enabling data to be returned to a user in a more user-friendly and efficient manner. For example, the data cubes can be OLAP data cubes, or any other suitable data cube. When building the data cubes, elements of such cubes can be mapped to data within the relational database. For instance, hierarchies within dimensions can relate to particular portions of the relational database. Further, the mapping functions described with respect to FIG. 1 can be utilized when building the relational database.

At 806, a report generating wizard is initialized, wherein the wizard is employed to assist a user in creating a desirable report. For instance, the report generating wizard can be initialized through selection of a graphical object, a sequence of keystrokes, upon voice commands, or any other suitable manner. At 808, input is provided to the report generating wizard to enable creation of a customized report. For instance, the input can relate to data that is desirably utilized in the report, location or name of a server housing the data, name of the report, manners in which the report is to be generated, and the like. At 810, the report, generated in accordance with the input received by the wizard, is presented to a user.

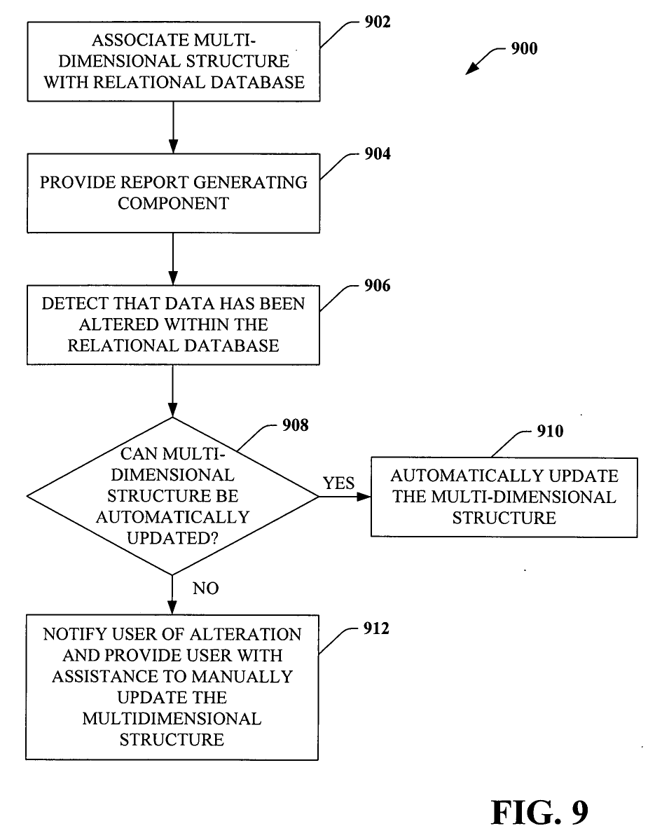

Referring now to FIG. 9, a method for maintaining a mapping between a multi-dimensional structure and a relational database is illustrated. At 902, a multi-dimensional structure is associated with a relational database. For instance, the multi-dimensional structure can be built in a manner that maps such structure to the relational database. In particular, the mapping functions described with respect to FIG. 1 can be utilized to facilitate associating the multi-dimensional structure with the relational database. At 904, a report generating component is provided, wherein such component is utilized to create and present a report associated with the data within the relational database. At 906, it is detected that data has been altered within the relational database. For instance, data and/or tables housing such data can be modified, added, or deleted, and such alterations can be detected. At 908, a determination is made regarding whether the multi-dimensional structure can be automatically updated to maintain a suitable mapping between the multi-dimensional structure and the relational database. For example, metadata can exist and be associated with the altered portion of the relational database, and upon analysis of such metadata the multi-dimensional structure can be automatically updated. If the multi-dimensional structure can be automatically updated, then at 910 the multi-dimensional structure is updated accordingly. If it is determined at 908 that the multi-dimensional structure cannot be automatically updated, at 912 the user is notified of the alteration and provided with assistance in manually updating the multi-dimensional structure to retain a suitable mapping with the relational database.

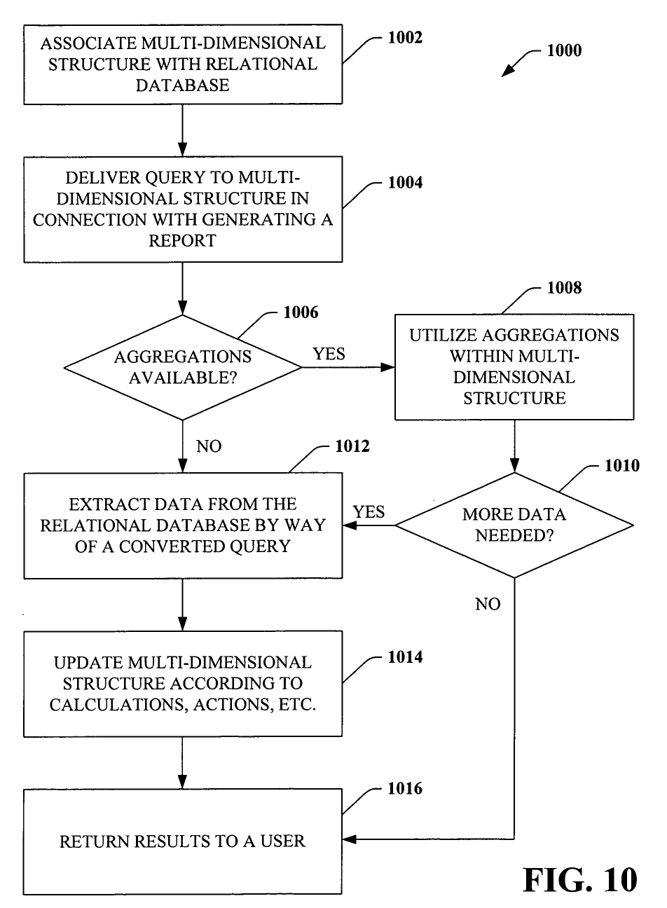

Referring now to FIG. 10, a methodology 1000 associated with relational reporting is illustrated. At 1002, a multi-dimensional structure is associated with a relational database, wherein such association is based at least in part upon the mapping functions described infra. At 1004, a query in a declarative language is delivered to the multi-dimensional structure, wherein such query is utilized in connection with generating a report. For example, the multi-dimensional structure can be an OLAP cube, and the declarative language can be MDX or any other suitable language that can be employed in connection with OLAP cubes. At 1006, a determination is made regarding whether aggregations are available within the cube relating to the query (which would expedite the process and not require certain calculations to be undertaken). If there are aggregations available, then at 1008 such aggregations within the multi-dimensional structure are utilized in connection with generating the report.

Thereafter a determination is made at 1010 regarding whether additional data is needed over the aggregations. If additional data is found to be requested by the query or no aggregations are available (determined at 1006), at 1012 data is extracted from the relational database by way of a converted query. For instance, a query in MDX can be delivered to an OLAP data cube, and such cube can be traversed to determine a mapping between the cube and desired data within the relational database. Thereafter, the query can be converted to an SQL query and applied to the relational database, and appropriate data can be extracted therefrom. At 1014, the multi-dimensional structure is updated according to calculations, actions, and the like undertaken against the data from the relational database. At 1016, results of the query are returned to the user in the form of a customized report. Similarly, if a determination is made at 1010 that no additional data is needed, then results can be returned to a user at 1016 directly after making such determination.

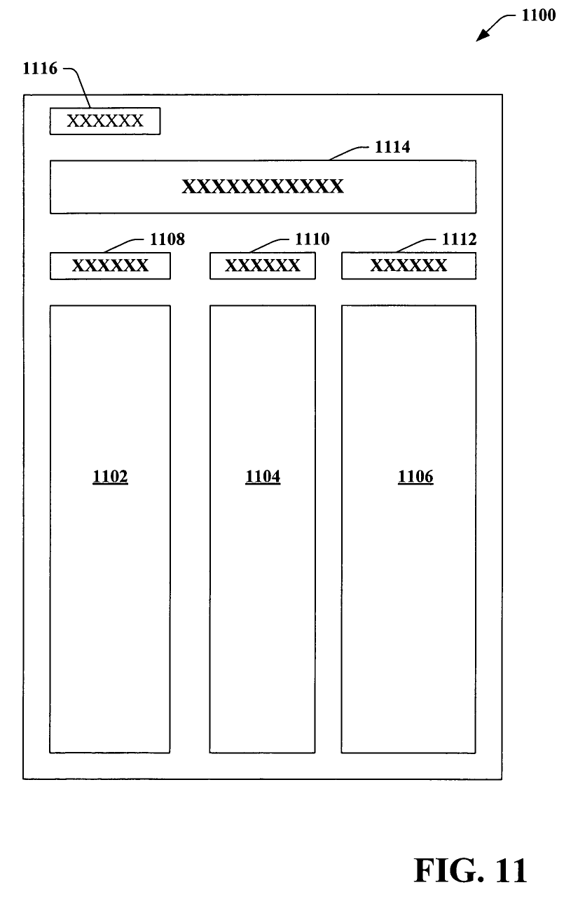

Now referring to FIG. 11, an exemplary report 1100 that can be created in accordance with one or more aspects of the subject invention is illustrated. The report 1100 can be customized according to various user specifications. For instance, the report 1100 can include data extracted from a relational database by way of a multi-dimensional structure that is formatted into three disparate columns 1102-1106. While three columns of data are shown in the report 1100, it is understood that data can be arranged in any suitable manner specified by a user (e.g., tables, rows, disparate number of columns, . . . ). The columns 1102-1106 can be associated with column titles 1108-1112 that are specifiable by the user, and such column titles 1108-1112 can be displayed in any suitable font of any suitable size. Furthermore, any text within the report can be associated with effects that are desired by the user, such as bold lettering, italicized lettering, underlined lettering, and the like. The report 1100 can further include a title 1114 that is also customizable by the user. For instance, positioning of lettering of the title 1114 (e.g., centered, justified, . . . ) can be specified by the user, as well as name of the title. The exemplary report 1100 also includes a header 1116 that includes information selected and/or specified by the user. Thus, a report generated in accordance with one or more aspects of the subject invention can be customized by the user to display particular data in a specified manner.

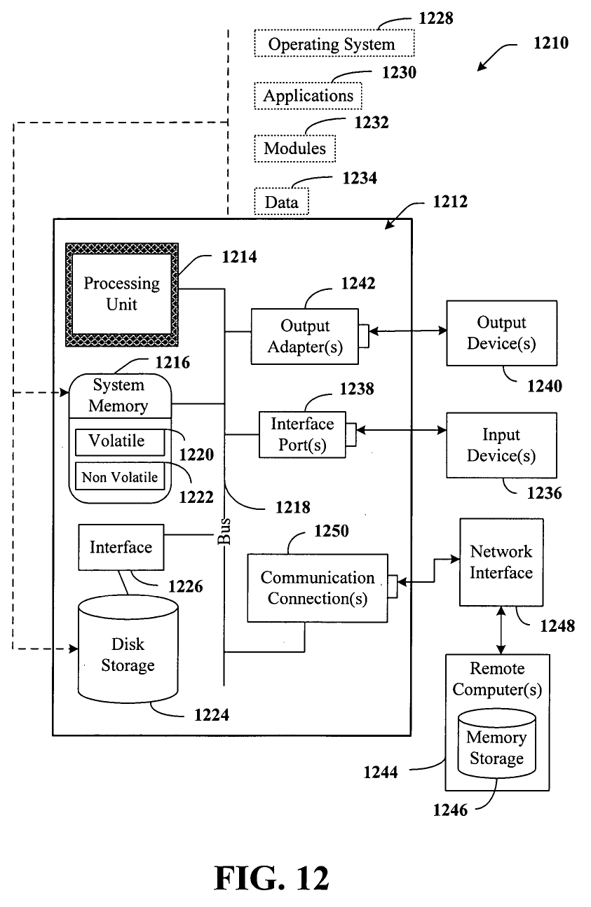

In order to provide additional context for various aspects of the subject invention, FIG. 12 and the following discussion are intended to provide a brief, general description of a suitable operating environment 1210 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1210 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/nonremovable, volatile/nonvolatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the subject invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

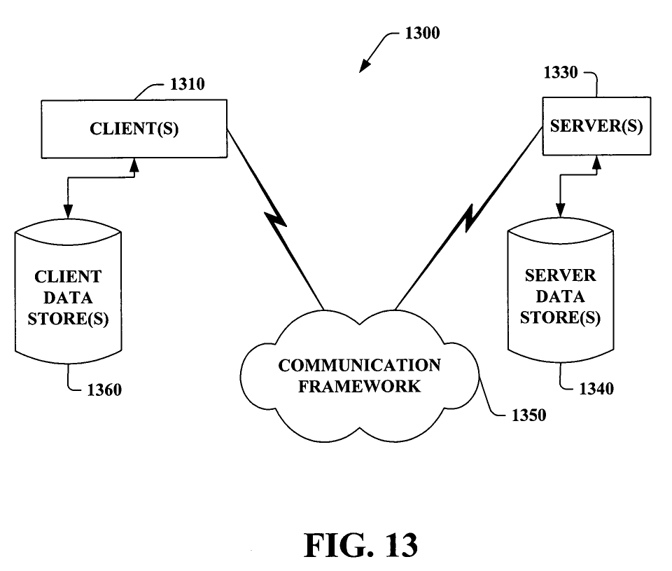

FIG. 13 is a schematic block diagram of a sample-computing environment 1300 with which the subject invention can interact. The system 1300 includes one or more client(s) 1310. The client(s) 1310 can be hardware and/or software (e.g., threads, processes, computing devices). The system 1300 also includes one or more server(s) 1330. The server(s) 1330 can also be hardware and/or software (e.g., threads, processes, computing devices). The servers 1330 can house threads to perform transformations by employing the subject invention, for example. One possible communication between a client 1310 and a server 1330 can be in the form of a data packet adapted to be transmitted between two or more computer processes. The system 1300 includes a communication framework 1350 that can be employed to facilitate communications between the client(s) 1310 and the server(s) 1330. The client(s) 1310 are operably connected to one or more client data store(s) 1360 that can be employed to store information local to the client(s) 1310. Similarly, the server(s) 1330 are operably connected to one or more server data store(s) 1340 that can be employed to store information local to the servers 1330.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates generating a report based upon data within a relational database, comprising:
a mapping component that utilizes mapping functions to associate a multi-dimensional structure with the relational database; and
a report generator that communicates with the multi-dimensional structure to obtain data relating to the relational database and generates a report that includes the obtained data.

2. The system of claim 1, the mapping component utilizes measure groups to effectuate the association between the multi-dimensional structure and the relational database.

3. The system of claim 2, measures on disparate measure groups are known at different granularities within a hierarchy.

4. The system of claim 1, the mapping component references a first dimension of the multi-dimensional structure to a second dimension of the multi-dimensional structure in connection with associating the multi-dimensional structure with the relational database.

5. The system of claim 1, the mapping component assigns a plurality of disparate roles to a dimension within the multi-dimensional structure in connection with associating the multi-dimensional structure with the relational database.

6. The system of claim 1, the mapping component associates a first group of dimensions within the multi-dimensional structure to a second group of dimensions within the multi-dimensional structure in connection with associating the multi-dimensional structure with the relational database.

7. The system of claim 1, the mapping component defines a dimension so that it includes a full set of attributes that comprises the dimension.

8. The system of claim 1, the multi-dimensional structure is one or more OLAP cubes.

9. The system of claim 1, the relational database is one or more OLTP databases.

10. The system of claim 1, further comprising a multi-dimensional structure generating tool that builds the multi-dimensional structure over the relational database.

11. The system of claim 1, further comprising a wizard component that solicits information from a user relating to parameters of the report.

12. The system of claim 11, the parameters relate to type of data to be included within the report, font of text associated with the report, manner in which to display data within the report, location of a server comprising the data to be included within the report, and name of the report.

13. The system of claim 1, further comprising a language component that causes the report to be output in a specified language.

14. The system of claim 1, the report generator issues a query in MDX to the multi-dimensional structure.

15. A method for creating a report that utilizes data within a relational database, comprising:
utilizing mapping functions to map a multi-dimensional structure to the relational database;
querying the multi-dimensional structure for data desirably included within the report; and
generating the report according to data returned in response to the query.

16. The method of claim 15, further comprising automatically updating the multi-dimensional structure upon determining that data within the relational database has been subject to alteration.

17. The method of claim 15, further comprising outputting the report in a user-specified language.

18. The method of claim 15, further comprising determining that a user associated with the query is authorized to receive the report.

19. The method of claim 15, the multi-dimensional structure is an OLAP cube.

20. A relational reporting system, comprising:
means for mapping a multi-dimensional structure to a relational database; and
means for utilizing the mapping to generate a relational database report.
